(19) United States
(12) Patent Application Publication
(10) Pub. No.: US 2026/0093212 A1
(43) Pub. Date: Apr. 2, 2026

(54) PRODUCTION INDUCED DAMAGE PREDICTION

(71) Applicant: Dell Products L P., Round Rock, TX (US)

(72) Inventors: Abhishek Mishra, Bangalore (IN); Vivek Bhargava, Bangalore (IN); Piyush Goswami, Bangalore (IN); Ajith Navada, Davangere (IN)

(21) Appl. No.: 18/902,788

(22) Filed: Sep. 30, 2024

(51) Int. Cl. G05B 13/02

(52) U.S. Cl. CPC G05B 13/0265

(57) ABSTRACT

A method for managing a product order request includes: obtaining historical data; analyzing the historical data to generate a data set that is associated with a set of parts of a first product; performing preprocessing on the data set to generate a preprocessed data set; generating, based on the preprocessed data set, a model that predicts part failure probability of each part of the set of parts; training the model to generate a trained model that, at least, identifies categories in the preprocessed data set and predicts part failure probability of each part listed in each category prior to a manufacturing process of a second product is initiated; receiving the request from a user; and identifying, using the trained model, a second set of parts that need to be used to manufacture the second product and the best vendor to procure each part of the second set of parts.

### BACKGROUND

Devices are often capable of performing certain functionalities that other devices are not configured to perform, or are not capable of performing. In such scenarios, it may be desirable to adapt one or more systems to enhance the functionalities of devices that cannot perform those functionalities.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example, and are not meant to limit the scope of the claims.

FIG. 1 shows a diagram of a system in accordance with one or more embodiments disclosed herein.

FIG. 2.1 shows a diagram of an infrastructure node in accordance with one or more embodiments disclosed herein.

FIG. 2.2 shows an example heat map in accordance with one or more embodiments disclosed herein.

FIG. 3.1-3.2 show a method for managing a product order request in accordance with one or more embodiments disclosed herein.

FIG. 4 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, production manufacturing may include three main stages: (a) part procurement, (b) building/assembly, and (c) delivery. The first stage may represent/include procurement of raw materials (or parts such as processors, memory, storage components, etc.) from various vendors, in which some vendors may supply a portion of the parts (or the parts) with additional features (e.g., while Vendor A's hard disk drive (HDD) is shipped within a protection case, Vendor B's HDD is shipped without a protection case; while Vendor C's random access memory (RAM) is a single-slot RAM, Vendor D's RAM is a multi-slot RAM; etc.) that may be supplemental to basic requirements of a product that is planned to be built.

In most use cases, before signing an agreement (e.g., a part procurement agreement) with a vendor, a corresponding administrator of an organization/manufacturer may need to (i) analyze what features (e.g., one or more warranties related to a part (or an order), how quickly the vendor can replace a damaged part, etc.) the vendor offers additionally and how those features may help building/maintaining a related product and (ii) determine/predict, based on historic data, what part(s) should be procured from which vendor to minimize a damage occurred to the product. These ((i)-(ii)) may in turn help an end-to-end product building process and delivery time for the product, and may increase efficiency of manufacturing people (who build the product) at the manufacturer.

From a different perspective, with the data in hand, administrators (and/or manufacturing people) may clearly infer that 15% to 20% of the overall product orders received by the manufacturer may face the issue(s) of damaged parts (e.g., parts that are shipped as damaged by a related vendor), wrong parts (e.g., incorrect parts that are shipped by a related vendor), and/or unavailable parts. Separately, in manufacturing space, determining the correct part and its lifespan (with its susceptibility to wear and tear) is vital because, during the assembly of a related product, cheap/incorrect parts may be more susceptible to damage (because of their low-quality / fragileness) and may increase the operating cost of the manufacturer (because the manufacturer may replace the incorrect parts and redo the whole assembly process from the beginning). As indicated, these issues/points may have a huge impact on the factory/manufacturing lead time of the product and on the operating cost of the manufacturer, which may in turn result in a delayed product delivery (e.g., to customers/users).

For at least the reasons discussed above and without requiring resource-intensive efforts (e.g., time, engineering, etc.), a fundamentally different approach/framework is needed (e.g., a framework that (i) predicts/determines, by using historical data and by employing a set of models (e.g., machine learning (ML) models), a correct vendor for procuring a part based on the criticality of a product order request, (ii) determines what features are offered by which vendor (e.g., which vendor provides multi-slot RAMs, which vendor can ship Part A within a week, which vendor can provide 3-year warranty for Part T, etc.), and (iii) determines the efficiency and usage of additional features provided/offered by each vendor (and their pricing factor)).

Embodiments disclosed herein relate to methods and systems for managing a product order request. As a result of the processes discussed below, one or more embodiments disclosed herein advantageously ensure that: (i) a trained (and/or fine-tuned) ML model is generated (by the framework) using historical data to determine/predict, at least, a correct vendor for procuring a part (based on the criticality of a product order request, details of the vendor, quality of features and parts provided by the vendor, etc.), what features are offered by which vendor, and the efficiency and usage of additional features provided/offered by each vendor (and their pricing factor); (ii) the framework determines quality of each part (of a related product) in an early stage of the product assembly/manufacturing process (e.g., the factory lead time of the product); (iii) by using historical data (of the parts that usually fails during the process) and parts procurement data (e.g., latest data that is used to procure parts for a related product, which may include different information comparing to the information specified in the historical data), the framework helps the administrators (and/or manufacturing people) to find/determine the correct vendor/supplier that is supplying and/or pre-stocking parts that are not prone to fail; (iv) the framework employs the trained model (during the product manufacturing process) to predict the sustainability of the corresponding parts and to predict the chances of failure of these parts; (v) the framework employs the trained model to identify failure rate of each part supplied from each vendor and details of each vendor to generate a report so that, upon their review, the administrators may infer the chances of failure of each part prior a related product manufacturing process is initiated and may initiate procurement of the correct parts from the correct vendors towards, for example, improving/minimizing the factory lead time of the product; (vi) the framework goes beyond further by predicting the failure probability of parts and the associated vendor(s), potentially leading to more targeted interventions (where traditional solutions/approaches focuses on predicting part failure probability in isolation); (vii) the framework incorporates additional features of the parts (e.g., material composition of a part, tolerance levels of the part, specific manufacturing processes used by different vendors while manufacturing the part, etc.) alongside the failure data of the parts (and their associated vendors), potentially leading to more nuanced and accurate predictions (where conventional solutions rely solely on historical part failure data to perform part failure predictions); (viii) the framework goes one step further (because binary outcomes do not provide granular details needed for precise decision-making) by incorporating manufacturing delay time into the vendor and part determination process in order to quantify impact of part failures, targeted interventions, vendor accountability, and backlog optimization on a related manufacturing process (where traditional part failure prediction solutions often focus on binary outcomes such as (a) failed or (b) not failed); (ix) the framework goes one step further by considering a desired backlog level (e.g., a desired stock availability of a particular part) in conjunction with failure predictions of that part, which may lead to develop more proactive procurement strategies to avoid stockouts and manufacturing delays (where existing systems may optimize part procurement based on predicted demand); (x) the framework utilizes metadata obtained from various sources to construct an inquiry system that enables data collection to develop an optimal ML model; (xi) the framework considers one or more parameters to perform part assessment without risking vendors to expose their logic (in order to provide the best communication to the manufacturing team/people with the vendors); and/or (xii) the framework goes one step further by simply relaying information by anticipating potential user/customer needs and, for a better user experience, provides the best possible solutions/products based on manufacturing capabilities and available parts (e.g., the framework has the ability to guide a customer towards making an optimal product choice even the customer does not ask the correct questions to make a decision on which product is the best for him/her).

The following describes various embodiments disclosed herein.

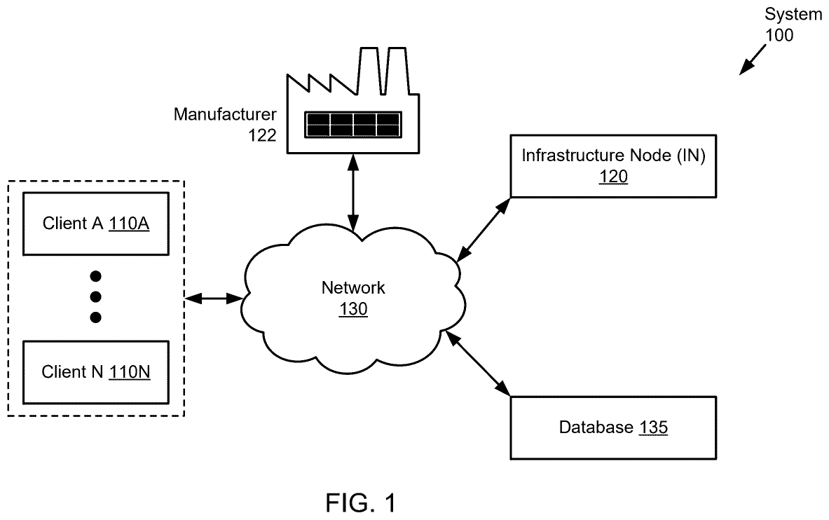

FIG. 1 shows a diagram of a system (100) in accordance with one or more embodiments disclosed herein. The system (100) includes any number of clients (e.g., Client A (110A), Client N (110N), etc.), a network (130), any number of infrastructure nodes (INs) (e.g., 120), a database (135), and a manufacturer (122). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the clients (e.g., 110A, 110N, etc.), the IN (120), the network (130), the database (135), and the manufacturer (122) may be (or may include) physical hardware or logical devices, as discussed below. While FIG. 1 shows a specific configuration of the system (100), other configurations may be used without departing from the scope of the embodiments disclosed herein. For example, although the clients (e.g., 110A, 110N, etc.) and the IN (120) are shown to be operatively connected through a communication network (e.g., 130), the clients (e.g., 110A, 110N, etc.) and the IN (120) may be directly connected (e.g., without an intervening communication network).

Further, the functioning of the clients (e.g., 110A, 110N, etc.) and the IN (120) is not dependent upon the functioning and/or existence of the other components (e.g., devices) in the system (100). Rather, the clients and the IN may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

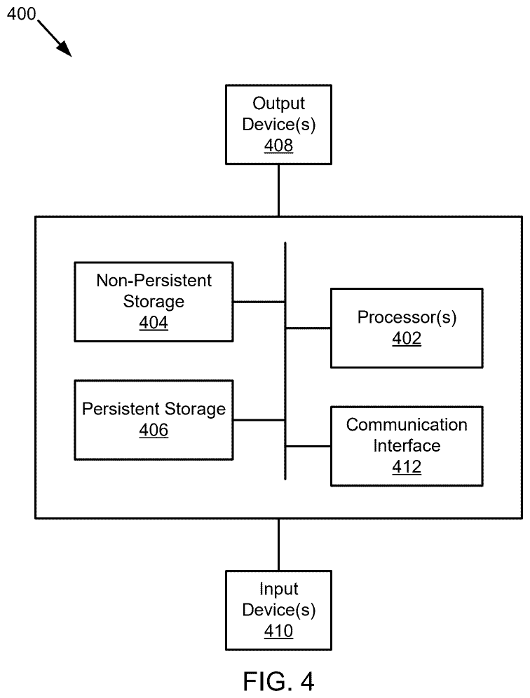

In one or more embodiments, the system (100) may be a distributed system (e.g., a data processing environment) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of clients (e.g., 110A, 110N, etc.). For example, the system may be configured to organize unbounded, continuously generated data into a data stream. The system (100) may also represent a comprehensive middleware layer executing on computing devices (e.g., 400, FIG. 4) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users'site using the clients (e.g., 110A, 110N, etc.)) and other computations remotely (e.g., away from the users'site using the IN (120)) from the users. By doing so, the users may utilize different computing devices (e.g., 400, FIG. 4) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the IN (120)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to the IN (120). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or computing device operated by one or more individuals of (or employed by) an organization. Examples of said individual(s) may include, but not limited to, any organization executive(s) (e.g., chief executive officer (CEO), chief financial officer (CFO), etc.) and any employee(s) in the data management team of the organization (e.g., an administrator). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the IN (120). For example, the clients may issue requests to the IN to receive responses and interact with various components of the IN. The clients may also request data from and/or send data to the IN (for example, the clients may transmit information to the IN that allows the IN to perform computations, the results of which are used by the clients to provide services to the users). As yet another example, the clients may utilize computer-implemented services provided by the IN. When the clients interact with the IN, data that is relevant to the clients may be stored (temporarily or permanently) in the IN.

In one or more embodiments, a client (e.g., 110A, 110N, etc.) may be capable of, e.g.,: (i) collecting users'inputs, (ii) correlating collected users'inputs to the computer-implemented services to be provided to the users, (iii) communicating with the IN (120) that perform computations necessary to provide the computer-implemented services, (iv) using the computations performed by the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high-speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): an HDD, a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the IN (120)) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8GB of PMEM and 1 CPU with 16 cores. Other different computational capabilities of the clients not listed above may also be taken into account without departing from the scope of the embodiments disclosed herein.

Further, in one or more embodiments, a client (e.g., 110A, 110N, etc.) may be implemented as a computing device (e.g., 400, FIG. 4). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., customers, administrators, organization executives, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing the virtualization technology. In one or more embodiments, an administrator may be a user/person/human with permission (e.g., a user that has root-level access) to make changes on the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 400, FIG. 4) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, the IN (120) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, the IN (120) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the database (135) for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or ML models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IN (not shown) for review and/or other human interactions; (x) exchange data with other devices registered in/to the network (130) in order to, for example, participate in a collaborative workload placement (e.g., the node may split up a request (e.g., an operation, a task, an activity, etc.) with another IN, coordinating its efforts to complete the request more efficiently than if the IN had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the database (135); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or database; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (120) may communicate with, for example, the database (135) and/or other storage devices in the system (100).

As described above, the IN (120) may be capable of providing a range of functionalities/services to the users of the clients (e.g., 110A, 110N, etc.). However, not all of the users may be allowed to receive all of the services. To manage the services provided to the users of the clients, a system (e.g., a service manager) in accordance with embodiments disclosed herein may manage the operation of a network (e.g., 130), in which the clients are operably connected to the IN. Specifically, the service manager (i) may identify services to be provided by the IN (for example, based on the number of users using the clients) and (ii) may limit communications of the clients to receive IN provided services.

For example, the priority (e.g., the user access level) of a user may be used to determine how to manage computing resources of the IN (120) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IN (120) (e.g., while the computing resources of the IN may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high-priority user (e.g., a privileged user, a user with a user access level of 9/10). In such a case, the user level of that user may indicate that more ports are to be opened than were for the first user so that (i) the IN (120) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

Further, while a single IN (e.g., 120) is considered above, the term “node” includes any collection of systems or sub-systems that individually or jointly execute a set, or multiple sets, of instructions to provide one or more computer-implemented services. For example, a single IN may provide a computer-implemented service on its own (i.e., independently) while multiple other nodes may provide a second computer-implemented service cooperatively (e.g., each of the multiple other nodes may provide similar and or different services that form the cooperatively provided service).

As described above, the IN (120) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, the IN (120) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

One of ordinary skill will appreciate that the IN (120) may perform other functionalities without departing from the scope of the embodiments disclosed herein.

In one or more embodiments, the IN (120) may be implemented as a computing device (e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN (120) may also be implemented as a logical device.

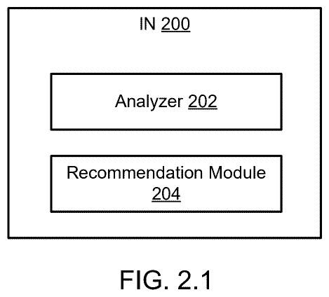

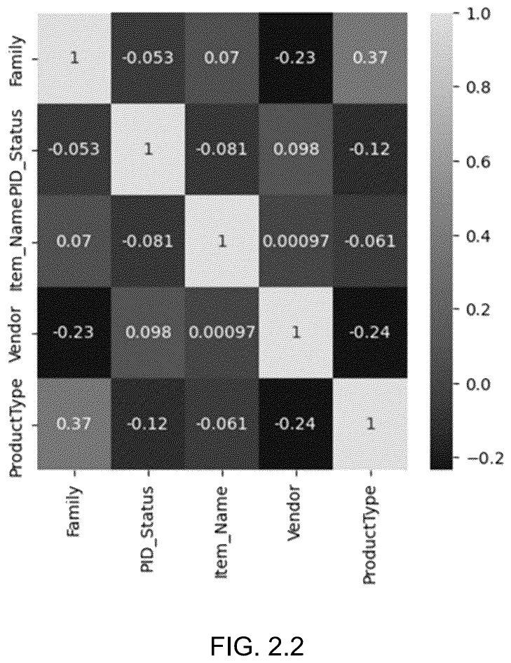

In one or more embodiments, the IN (120) may host an analyzer (e.g., 202, FIG. 2.1) and a recommendation module (e.g., 204, FIG. 2.1). Referring to FIG. 2.1, the analyzer (202) and the recommendation module (204) are demonstrated as part of the IN (e.g., as deployed to the IN); however, embodiments disclosed herein are not limited as such. The analyzer (202) and the recommendation module (204) may be demonstrated as deployed to the manufacturer (122) (e.g., as part of the manufacturer (122)).

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IN, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the IN through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

Turning now to the database (135), the database (135) may provide long-term, durable, high read/write throughput data storage/protection with near-infinite scale and low-cost. The database (135) may be a fully managed cloud/remote (or local) storage (e.g., cold tier storage, pluggable storage, object storage, block storage, file system storage, data stream storage, Web servers, unstructured storage, etc.) that acts as a shared storage/memory resource that is functional to store unstructured and/or structured data. Further, the database (135) may also occupy a portion of a physical storage/memory device or, alternatively, may span across multiple physical storage/memory devices.

In one or more embodiments, the database (135) may be implemented using physical devices that provide data storage services (e.g., storing data and providing copies of previously stored data). The devices that provide data storage services may include hardware devices and/or logical devices. For example, the database (135) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (135) may include a memory device (e.g., a dual in-line memory device), in which data is stored and from which copies of previously stored data are provided. As yet another example, the database (135) may include a persistent storage device (e.g., an SSD), in which data is stored and from which copies of previously stored data is provided. As yet another example, the database (135) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database (135) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the database (135) may store/record unstructured and/or structured data that may include (or specify), for example (but not limited to): an identifier of a user/customer (e.g., a unique string or combination of bits associated with a particular user); a request received from a user (or a user's account); a geographic location (e.g., a country) associated with the user; a timestamp showing when a specific request is processed by an application; a port number (e.g., associated with a hardware component of a client (e.g., 110A)); a protocol type associated with a port number; computing resource details (including details of hardware components and/or software components) and an IP address of an IN (e.g., 120) hosting an application where a specific request is processed; an identifier of an application (e.g., that is deployed by the manufacturer (122) to the database); information with respect to historical metadata (e.g., system logs, applications logs, telemetry data including past and present device usage of one or more computing devices in the system (100), etc.); computing resource details and an IP address of a client that sent a specific request (e.g., to the IN (120)); one or more points-in-time and/or one or more periods of time associated with a data recovery event; data for execution of applications/services (including IN applications and associated end-points); corpuses of annotated data used to build/generate and train processing classifiers for trained ML models; linear, non-linear, and/or ML model parameters (e.g., instructions to the recommendation module (e.g., 204, FIG. 2.1) on how to train and/or fine-tune a model); an identifier of a sensor; a product identifier of a client (e.g., 110A); a type of a client; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; a distributed model identifier that uniquely identifies a distributed model; a user activity performed on a data item; a cumulative history of user/administrator activity records obtained over a prolonged period of time; a setting (and a version) of a mission critical application executing on an IN (e.g., 120); an SLA/SLO set by a user; a data protection policy (e.g., an affinity-based backup policy) implemented by a user (e.g., to protect a local data center, to perform a rapid recovery, etc.); a configuration setting of that policy; product configuration information associated with a client; a number of each type of a set of assets protected by an IN (e.g., 120); a size of each of the set of assets protected; a number of each type of a set of data protection policies implemented by a user; configuration information associated with the analyzer (e.g., 202, FIG. 2.1); a job detail of a job (e.g., a data protection job, a data restoration job, a log retention job, etc.) that has been initiated by an IN (e.g., 120); a type of the job (e.g., a non-parallel processing job, a parallel processing job, an analytics job, etc.); information associated with a hardware resource set (discussed below) of the IN (120); a completion timestamp encoding a date and/or time reflective of a successful completion of a job; a time duration reflecting the length of time expended for executing and completing a job; a backup retention period associated with a data item; a status of a job (e.g., how many jobs are still active, how many jobs are completed, etc.); a number of requests handled (in parallel) per minute (or per second, per hour, etc.) by the analyzer; a number of errors encountered when handling a job; a documentation that shows how the analyzer performs against an SLO and/or an SLA; information regarding an administrator (e.g., a high-priority trusted administrator, a low-priority trusted administrator, etc.) related to an analytics job; a workflow (e.g., a policy that dictates how a workload should be configured and/or protected, such as a structured query language (SQL) workflow dictates how an SQL workload should be protected) set (by a user); a type of a workload that is tested/validated by an administrator per data protection policy; a practice recommended by a vendor (e.g., a single data protection policy should not protect more than 100 assets; for a dynamic NAS, maximum one billion files can be protected per day, etc.); one or more device state paths corresponding to a device (e.g., a client); an existing knowledge base (KB) article; a technical support history documentation of a customer/user; a port's user guide; a port's release note; a community forum question and its associated answer; a catalog file of an application upgrade; details of a compatible OS version for an application upgrade to be installed; an application upgrade sequence; a solution or a workaround document for a software failure; one or more lists that specify which computer-implemented services should be provided to which user (depending on a user access level of a user); a fraud report for an invalid user; a set of SLAs (e.g., an agreement that indicates a period of time required to retain a profile of a user); information with respect to a user/customer experience; a shipping address of a customer/user/person; a billing address of a customer; a unit price of a product (e.g., a computer, a monitor, a keyboard, a mouse, etc.) hardware component ordered by a customer; a detail of a product ordered by a customer; recently obtained customer information (e.g., records, credentials, etc.); one or more details of a received product purchase order (or a purchase/sales order); an identifier of a vendor; a purchase order number; a payment term (e.g., 15 months) set for a purchase order; a cumulative history of received purchase orders (from a specific customer) over a prolonged period of time; a documentation that indicates a set of jobs (e.g., a purchase order job, a product deployment job, etc.) that has been generated; information about a valid user that has initiated a recent purchase order process; a valid (e.g., a granted) purchase order request and its corresponding details; an invalid (e.g., a rejected) purchase order request and its corresponding details; one or more details (e.g., content of the transmitted data packets, information regarding a targeted destination, etc.) of a recently initiated purchase order process; one or more details of a recently completed product manufacturing process; historical product based faulty part data (described below); historical vendor based procured part data (described below); etc.

In one or more embodiments, information associated with a hardware resource set (e.g., including at least resource related parameters) may specify, for example (but not limited to): a configurable CPU option (e.g., a valid/legitimate vCPU count per IN in the system (100)), a configurable network resource option (e.g., enabling/disabling single-root input/output virtualization (SR-IOV) for the IN (120)), a configurable memory option (e.g., maximum and minimum memory per IN in the system (100)), a configurable GPU option (e.g., allowable scheduling policy and/or virtual GPU (vGPU) count combinations per IN in the system (100)), a configurable DPU option (e.g., legitimacy of disabling inter-integrated circuit (I2C) for various INs in the system (100)), a configurable storage space option (e.g., a list of disk cloning technologies across one or more INs in the system (100)), a configurable storage input/output (I/O) option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QoS) template), a DPU related template (e.g., a 1 GB/s BW vDPU with 1 GB vDPU frame buffer template), a GPU related template (e.g., a depth-first vGPU with 1 GB vGPU frame buffer template), a storage space related template (e.g., a 40 GB SSD storage template), a CPU related template (e.g., a 1 vCPU with 4 cores template), a memory resource related template (e.g., an 8 GB DRAM template), a vCPU count per analytics engine, a virtual NIC (vNIC) count per IN in the system (100), a wake on LAN support configuration (e.g., supported/enabled, not supported/disabled, etc.), a vGPU count per IN in the system (100), a type of a vGPU scheduling policy (e.g., a “fixed share” vGPU scheduling policy), a storage mode configuration (e.g., an enabled high-performance storage array mode), etc.

In one or more embodiments, as being telemetry data, a system log (e.g., a file that records system activities across hardware and/or software components of a client, an internal lifecycle controller log (which may be generated as a result of internal testing of a NIC), etc.) may include (or specify), for example (but not limited to): a type of an asset (e.g., a type of a workload such as an SQL database, a NAS executing on-premises, a VM executing on a multi-cloud infrastructure, etc.) that is utilized by a user; computing resource utilization data (or key performance metrics including estimates, measurements, etc.) (e.g., data related to a user's maximum, minimum, and average CPU utilizations, an amount of storage or memory resource utilized by a user, an amount of networking resource utilized by user to perform a network operation, etc.) regarding computing resources of a client (e.g., 110A); an alert that is triggered in a client (e.g., based on a failed cloud disaster recovery operation (which is initiated by a user), the client may generate a failure alert); an important keyword associated with a hardware component of a client (e.g., recommended maximum CPU operating temperature is 75° C.); a computing functionality of a microservice (e.g., Microservice A's CPU utilization is 26%, Microservice B's GPU utilization is 38%, etc.); an amount of storage or memory resource (e.g., stack memory, heap memory, cache memory, etc.) utilized by a microservice (e.g., executing on a client); a certain file operation performed by a microservice; an amount of networking resource utilized by a microservice to perform a network operation (e.g., to publish and coordinate inter-process communications); an amount of bare metal communications executed by a microservice (e.g., I/O operations executed by the microservice per second); a quantity of threads (e.g., a term indicating the quantity of operations that may be handled by a processor at once) utilized by a process that is executed by a microservice; an identifier of a client's manufacturer; media access control (MAC) information of a client; an amount of bare metal communication executed by a client (e.g., I/O operations executed by a client per second); etc.

In one or more embodiments, an alert (e.g., a predictive alert, a proactive alert, a technical alert, etc.) may be defined by a vendor of a corresponding client (e.g., 110A), by an administrator, by another entity, or any combination thereof. In one or more embodiments, an alert may specify, for example (but not limited to): a medium-level of CPU overheating is detected, a recommended maximum CPU operating temperature is exceeded, etc. Further, an alert may be defined based on a data protection policy.

In one or more embodiments, an important keyword may be defined by a vendor of a corresponding client (e.g., 110A), by a technical support specialist, by the administrator, by another entity, or any combination thereof. In one or more embodiments, an important keyword may be a specific technical term or a vendor specific term that is used in a system log.

In one or more embodiments, as being telemetry data, an application log may include (or specify), for example (but not limited to): a type of a file system (e.g., a new technology file system (NTFS), a resilient file system (ReFS), etc.); a product identifier of an application; a version of an OS that an application is executing on; a display resolution configuration of a client; a health status of an application (e.g., healthy, unhealthy, etc.); warnings and/or errors reported for an application; a language setting of an OS; a setting of an application (e.g., a current setting that is being applied to an application either by a user or by default, in which the setting may be a font option that is selected by the user, a background setting of the application, etc.); a version of an application; a warning reported for an application (e.g., unknown software exception (0xc00d) occurred in the application at location 0x0007d); a type of an OS (e.g., a workstation OS); an amount of storage used by an application; a size of an application (size (e.g., 5 Megabytes (5 MB), 5 GB, etc.) of an application may specify how much storage space is being consumed by that application); a type of an application (a type of an application may specify that, for example, the application is a support, deployment, or recycling application); a priority of an application (e.g., a priority class of an application, described below); active and inactive session counts; etc.

As used herein, “unhealthy” may refer to a compromised health state (e.g., an unhealthy state), indicating a corresponding entity (e.g., a hardware component, a client, an application, etc.) has already or is likely to, in the future, be no longer able to provide the services that the entity has previously provided. The health state determination may be made via any method based on the aggregated health information without departing from the scope of the embodiments disclosed herein.

In one or more embodiments, the historical product based faulty part data may include (or specify), for example (but not limited to): information with respect to a physically damaged part, one or more reasons explaining why the part is physically damaged (e.g., the physical damage is caused by a related vendor, the physical damage is caused by a manufacturing person while assembling a related product, etc.), information/details of that vendor (who provided the part), a type of a product (e.g., a gaming laptop, a monitor, a workstation computer, etc.), a stage of a manufacturing process of a product that a physically damaged part is identified, a product test report associated with a product identifying a delay occurred during a manufacturing process of the product (and further specifying, for example, tests results of a faulty product (e.g., touch pad driver installation is failed, touch pad printed circuit board is changed; some of the keyboard key are not operating as expected; a palmrest keyboard cable is not installed; a damage on the display is detected; etc.)), information with respect to a logically damaged part, one or more reasons explaining why the part is logically damaged (e.g., the logical damage is caused by a related vendor, the logical damage is caused by a manufacturing person while booting a related product, etc.), etc.

In one or more embodiments, the historical vendor based procured part data may include (or specify), for example (but not limited to): an order number of a part that is procured from a first vendor, a previously generated service tag that is associated with a second part, a family of a part, an identifier of a part/item, a type of a part, an identifier (or information) of the first vendor that provided a part of a set of parts that needs to be procured to manufacture a product, an identifier of a product in which the part procured from the first vendor is used during a manufacturing process of the product, a production induced damage (PID) status of a part that is procured from a second vendor (e.g., no damage is detected, use the part as is; a physical damage is detected, return to the second vendor; a physical damage is detected, scrap the part to a scrap vendor; etc.), an identifier of a manufacturing person who tested the part that is procured from the second vendor, a timestamp encoding a date and/or time reflective of when the manufacturing person performed the test, a type of a product, a failure rate of a second part of the set of parts that is procured from the first vendor, billing information with details of the part procured from the first vendor, an additional feature (e.g., shipping the part within a protection case, the part is accompanied with a multi-slot RAM, the part is accompanied with a 3-year warranty, etc.) provided by the first vendor when the part is procured from the first vendor, a first geographic location of the first vendor, a second geographic location of the second vendor, a first rating of the first vendor (e.g., a trusted vendor (because the parts procured from the first vendor are 95% of the time in a good condition and not damaged), an untrusted vendor (because the parts procured from the first vendor are usually in a bad condition and damaged), etc.), a period of time required to procure a third part from the first vendor (e.g., after a procurement request is sent to the first vendor, it usually takes three weeks to receive the part from the first vendor), a first set of parts that can be procured from the first vendor, a second set of parts that can be procured from the second vendor, etc.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored in the database (135), any of the aforementioned data structures may be stored in different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) (provided by the manufacturer (122)) and/or by the administrators based on, for example, newer (e.g., updated) versions of SLAs. The unstructured and/or structured data may also be updated when, for example (but not limited to): newer system logs are received, a state of an IN (e.g., 120) is changed, etc.

While the database (135) has been illustrated and described as including a limited number and type of data, the database (135) may store additional, less, and/or different data without departing from the scope of the embodiments disclosed herein. One of ordinary skill will appreciate that the database (135) may perform other functionalities without departing from the scope of the embodiments disclosed herein.

Turning now to the manufacturer (122), as being a trusted facility/site, the manufacturer (122) may be part of a supply chain route (that may be traversed by an enterprise product), in which the supply chain route may outline a sequence of trusted sites through which the enterprise product transitions during its lifetime.

In one or more embodiments, the manufacturer (122) may reference a trusted facility where a supplier of an enterprise product (e.g., a physical product such as an edge device, a logical product such as a software program or an application, etc.) may manufacture the enterprise product in part or in entirety. Manufacturing of an enterprise product may include one or more steps/stages, for example (but not limited to): steps of a developer/administrator flow of an application; steps of generating an ownership voucher (OV) (based on the credentials specified in device initialization (DI) process/protocol (where the OV may not be stored in the corresponding edge device; instead, the OV may be transmitted along the supply chain route to mirror the edge device's progress); steps of initial provisioning of an edge device; steps of generating a public and private key pair for an edge device (before shipping the edge device to a user/customer), where the public key of the key pair is embedded into a corresponding OV; manufacturing of chassis and front panel parts; subassembly of chassis parts to obtain a chassis; integration of a chassis and front panel parts to obtain a chassis enclosure; procurement of a power supply and/or cables and/or a backplane; integration of a power supply and/or cables and/or a backplane into a chassis enclosure; procurement of a baseboard and integration thereof into a chassis enclosure; procurement of one or more expansion cards and integration thereof into a chassis enclosure; procurement of one or more storage devices and integration thereof into a chassis enclosure; procurement of parts such as computer processors (e.g., CPUs, DPUs, etc.) as well as computer memory and integration thereof into a chassis enclosure to obtain a fully-assembled enterprise product; installation of an OS, zero or more software applications, and/or firmware onto a fully-assembled enterprise product to obtain a fully-integrated enterprise product; etc.

In one or more embodiments, the aforementioned enterprise product manufacturing steps may be performed across one or more manufacturers. Further, the manufacturer (122) may include functionality to service, upgrade, troubleshoot, test, package, and/or distribute various different enterprise products. One of ordinary skill will appreciate that the manufacturer (122) may perform other functionalities without departing from the scope of the embodiments disclosed herein.

While FIG. 1 shows a configuration of components, other system configurations may be used without departing from the scope of the embodiments disclosed herein.

Turning now to FIG. 2.1, FIG. 2.1 shows a diagram of an IN (200) in accordance with one or more embodiments disclosed herein. The IN (200) may be an example of the IN discussed above in reference to FIG. 1. The IN (200) includes the analyzer (202) and the recommendation module (204). The IN (200) may include additional, fewer, and/or different components without departing from the scope of the embodiments disclosed herein. Each component may be operably connected to any of the other component via any combination of wired and/or wireless connections. Each component illustrated in FIG. 2.1 is discussed below.

In one or more embodiments, the analyzer (202) may include functionality to, e.g.,: (i) obtain/retrieve, at least, historical data (including, at least, historical product based faulty part data (described above in reference to FIG. 1) and historical vendor based procured part data (described above in reference to FIG. 1)) from the database (e.g., 135, FIG. 1); (ii) by employing a set of linear, non-linear, and/or ML models, analyze/process the historical data to generate a data set that is associated with one or more targeted parts of a product (e.g., that is previously manufactured at the manufacturer (e.g., 122, FIG. 1)); (iii) perform, by employing a set of linear, non-linear, and/or ML models, preprocessing (e.g., data cleaning, data normalization, data transformation, etc.) on/of the data set to generate/obtain a preprocessed/structured data set (so that the data set will be prepared for further processes, for example, model generation, model training, model fine-tuning, etc.); and/or (iv) provide the preprocessed data set to the recommendation module (204) for further processes.

In one or more embodiments, the data set may specify (or include), for example (but not limited to): an identifier of a part, an identifier of a vendor that provided the part prior to manufacture a first product, an identifier of a second part, an identifier of a second vendor that provided the second part prior to manufacture the first product, a type of the first product, a first geographic location of the first vendor, a second geographic location of the second vendor, a first rating of the first vendor, a second rating of the second vendor, a heat map (see FIG. 2.2) illustrating an impact of each part/item on a previously manufactured product (e.g., the first product) (so that based on at least this information, the recommendation model (204) may generate a model and then train the model, which may identify at least which parts need to be considered/procured from which vendor in order to manufacture a second product), the part can be procured from four different vendors, a category for each part (where each category specifies (i) historical product based faulty part data and (ii) historical vendor based procured part data associated with a corresponding part), a set of parts that can be procured from the second vendor, etc.

One of ordinary skill will appreciate that the analyzer (202) may perform other functionalities without departing from the scope of the embodiments disclosed herein. The analyzer (202) may be implemented using hardware (e.g., any number of integrated circuits for processing computer readable instructions), software (e.g., a computer program executing on the underlying hardware of the IN (200)), or any combination thereof.

In one or more embodiments, the recommendation module (204) may include functionality to, e.g.,: (i) obtain/receive the preprocessed data set from the analyzer (202); (ii) generate, based on the preprocessed data set, a model that, at least, proactively predicts part failure probability of each of the targeted parts (e.g., predicts sustainability of each part and forecasts the chance of failure of each part during manufacturing of a related product) and determines possible production delays that may be occurred because of part failure and delayed part procurement; (iii) train, by employing a set of algorithms, the model to generate a trained model that, at least, (a) identifies one or more categories in the preprocessed data set and (b) calculates/predicts part failure probability of each part in each category (e.g., prior to the manufacturing process of a related product is initiated); (iv) initiate, via a GUI of the IN (200), notification of an administrator about the trained model; (v) (at a later point-in-time where the notification is sent to the administrator) receive a product order request from an entity (e.g., a user of a client (e.g., 110A, FIG. 1)), in which the request specifies information with respect to a related product the entity, for example, purchase/order; (vi) identify, upon receiving the request and by the employing the trained model, at least, (a) parts/items that need to be used to manufacture the product and (b) which is the best vendor to procure each part in order to minimize/improve manufacturing lead time of the product; (vii) initiate, based on the identifying, the manufacturing process of the product, for example, by sending a notification, via a GUI of the manufacturer (e.g., 122, FIG. 1), to a manufacturing person at the manufacturer; and/or (viii) initiate, via the GUI of the IN (200), notification of the administrator to indicate that the manufacturing process of the product has been initiated.

In one or more embodiments, the model may be a combination/mean of a linear regression model, a decision tree classifier model, a random forest model, and/or an extreme gradient boosting model.

As indicated above, generation, retraining, adjustment, and/or fine-tuning (e.g., based on an administrator of the IN (200), when newer/better procurement data is received, in order to increase the accuracy of the trained model in different conditions, etc.) of the trained model may be performed by the recommendation module (204) (in conjunction with the analyzer (202)).

In one or more embodiments, to consider custom data (e.g., newer/better procurement data) in the trained model, an administrator may need to include the custom data in an input prompt before sending the prompt to a model API of the recommendation module (204). To manage the custom data more effectively, the custom data may be transformed into one or more embedding vectors and stored to a vector database (not shown, in which content embeddings may also be stored to the vector database). These vectors may then be retrieved based on the prompt, and the resulting data may be combined with the prompt to form a newer prompt (e.g., to subsequently invoke the trained model in order to obtain responses that consider the custom data).

Despite the generalization capabilities of the trained model, issues may arise when applying the trained model to use cases that require organization (or business) domain knowledge. For example, in an organization setting with various types of components, if images of these components (e.g., a product catalog including one or more parts that need to be used to manufacture a related product) have not been part of the model's training data, distinguishing these images may be challenging. To prevent that (and/or upon receiving feedback from the administrator indicating that the accuracy of the trained model is low/dissatisfactory), the recommendation module (204) may fine-tune the trained model to obtain a fine-tuned trained model. To fine-tune, the recommendation module (204) may (i) request/obtain annotated data sets (e.g., to address specific part requirements of a related product (or product manufacturing process)) (after the annotated data sets are first preprocessed by the analyzer (202)), (ii) freeze one or more portions of the trained model's parameters (e.g., fixing or freezing 80% parameters of the trained model during the fine-tuning), (iii) retrain the trained model (especially, for example, if a vendor-specific custom part data has been updated, the trained model may need to be retrained); and/or (iv) use in-context learning capabilities of the trained model (by, for example, (a) externalizing a custom KB from model calls, (b) searching for relevant knowledge in the base, (c) rebuilding prompts, and/or (d) recalling the model).

In one or more embodiments, the recommendation module (204) may be configured to obtain output(s) of trained components, determine errors related to the components, and generate a parameter update for the components according to the errors. In one or more embodiments, the recommendation module (204) may generate the parameter update using any appropriate training method. For example, the recommendation module (204) may use one or more of supervised learning, unsupervised learning, semi-supervised learning, self-supervised learning, distillation learning, and/or adversarial learning.

In one or more embodiments, the set of algorithms/rules may direct the recommendation module (204) to perform the following steps (to train the model), e.g.,: (i) calculate, by employing a probabilistic classifier model (which can make predictions based on a probability of an object), a probability of occurrence of each part failure in a different category (e.g., “product type”, “vendor identifier”, “family”, “part/item identifier (or serial number)”, “vendor location”, “purchase order number”, “order status”, etc., specified in the preprocessed data set); and (ii) to perform (i), calculate the probability of part failure occurrence (of each part) in training data (i.e., the preprocessed data set), in which the expect output will be the probability of part failure occurrence (of each part) in the training data set.

In one or more embodiments, the training data may be fed into the probabilistic classifier model (e.g., a Naïve Bayer classifier model), which may learn a prior probability of part failure of each part (in a given category) to predict a probability of part failure of each part (e.g., display failure, RAM failure, GPU failure, memory failure, etc.) after a related product's manufacturing process is completed. For example, consider a scenario where Part A (e.g., RAM) and Part B (e.g., HDD) are procured from Vendor T, in which the probability of part failure of Part A is 30% and the probability of part failure of Part B is 20%. Based on this information and as a result of the training, the trained model may determine that the probability of part failure of Part C (e.g., SSD) (which is (i) planned to be procured from Vendor T and (ii) listed under the same category (e.g., storage peripherals) as Part A and Part B) as 10%.

Further, once the trained model is obtained, the trained model may be used to classify newer instances of data based on the prior probability of part failure of each part (learned from the training data), in which the trained model may calculate/predict (i) the probability of part failure of each part prior to initiating a manufacturing process of a related product and (ii) where to procure each part in order to minimize manufacturing lead time of the product.

As indicated above, using/considering feedback (e.g., positive feedback, negative feedback, etc.) received from the administrator as input, via the GUI of the IN (200), may cause the recommendation module (204) to be considered as a closed-loop system because the recommendation module (204) uses feedback in generating models. In light of this, the system (e.g., 100, FIG. 1) may support customization and continuous adjustments (e.g., of the models employed by the recommendation module (204)) to match an administrator's definition of, for example, faulty part and/or non-faulty part.

One of ordinary skill will appreciate that the recommendation module (204) may perform other functionalities without departing from the scope of the embodiments disclosed herein. The recommendation module (204) may be implemented using hardware (e.g., any number of integrated circuits for processing computer readable instructions), software (e.g., a computer program executing on the underlying hardware of the IN (200)), or any combination thereof.

In one or more embodiments, the analyzer (202) and the recommendation module (204) may be utilized in isolation and/or in combination to provide the aforementioned functionalities. These functionalities may be invoked using any communication model including, for example, message passing, state sharing, memory sharing, etc.

Turning now to FIG. 2.2, FIG. 2.2 shows an example heat map in accordance with one or more embodiments disclosed herein.

Referring to FIG. 2.2, as being part of the preprocessed data set, the example heat map may be a category/feature relationship bucket/pattern illustrating, at least, an impact of each part/item on a previously manufactured product, where, based on the information provided in the heat map, the recommendation model (e.g., 204, FIG. 2.1) may generate the model and then train the model to obtain the trained model (which may identify at least which parts need to be considered/procured from which vendor in order to manufacture a corresponding product).

As indicated, the example heat map may specify different categories/features (vertically and horizontally) such as “family” (e.g., a family of a part/item), “PID_Status” (e.g., a PID status of a part such as a damaged part or a non-damaged part), “item_name” (e.g., an identifier (or a serial number) of a part), “vendor” (e.g., information of a vendor where a part is produced, such as the vendor's location, the vendor's identifier, etc.), and “productType”(e.g., a type of a product where a corresponding part is used).

Further, the example heat map may also illustrate a relationship/correlation between each category (indicated the grade of grayscale) such as a positive correlation (indicated by a positive number/value) and a negative correlation (indicated by a negative number), in which a positive correlation (0.098) between “vendor” and “PID_Status” may mean that when “vendor” is considered by the trained model (or while training the model) as a feature, “PID_Status” should also be considered as a feature. Similarly, a negative correlation (−0.053) between “family” and “PID_Status” may mean that when “family” is not considered by the trained model (or while training the model) as a feature, “PID_Status”should also be not considered as a feature.

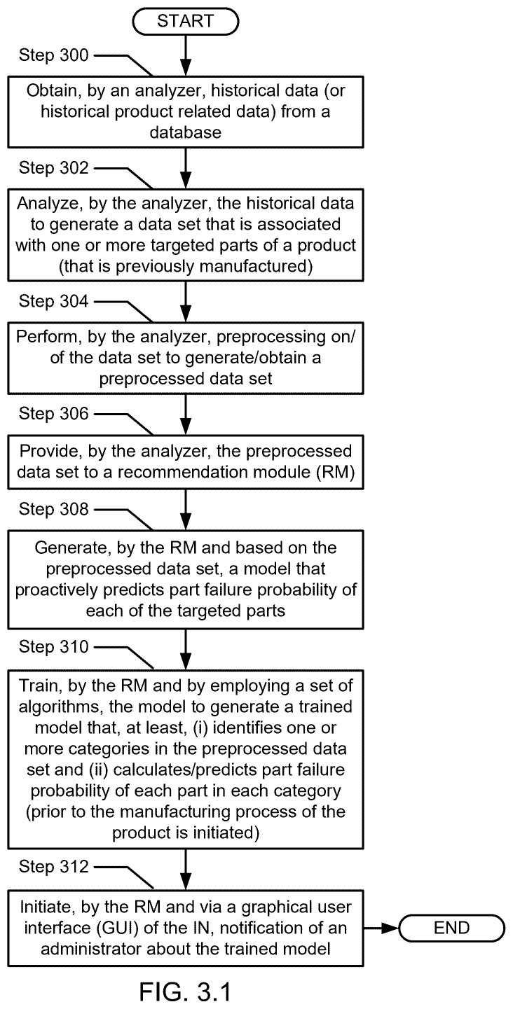

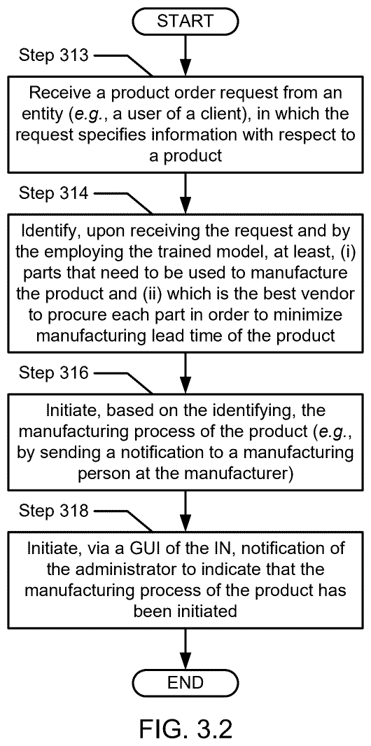

FIG. 3.1-3.2 show a method for managing a product order request in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 3.1, the method shown in FIG. 3.1 may be executed by, for example, the above-discussed analyzer (e.g., 202, FIG. 2.1) and recommendation module (e.g., 204, FIG. 2.1). Other components of the system (100) illustrated in FIG. 1 may also execute all or part of the method shown in FIG. 3.1 without departing from the scope of the embodiments disclosed herein.

In Step 300, the analyzer obtains/retrieves, at least, historical data (or historical product related data) from the database (e.g., 135, FIG. 1). Details of the historical data are described above in reference to FIG. 1.

In one or more embodiments, before obtaining the historical data, the analyzer may invoke the database to communicate with the database. After receiving the database's confirmation, the analyzer may obtain the historical data from the database. The historical data may be obtained continuously or at regular intervals (e.g., every two minutes) (without affecting production workloads of the database and the analyzer). Further, the historical data may be access-protected for the transmission from, for example, the database to the analyzer, e.g., using encryption.

In one or more embodiments, the historical data may be obtained as it becomes available or by the analyzer polling the database (via one or more API calls) for newer information. For example, based on receiving an API call from the analyzer, the database may allow the analyzer to obtain newer information.

In Step 302, upon receiving the historical data and by employing a set of linear, non-linear, and/or ML models, the analyzer analyzes/processes the historical data to generate a data set that is associated with one or more targeted parts/items (e.g., GPU, CPU, SSD, RAM, motherboard, display, etc.) of a product (e.g., that is previously manufactured). In Step 304, by employing a set of linear, non-linear, and/or ML models, the analyzer performs preprocessing on/of the data set to generate/obtain a preprocessed data set. Thereafter, in Step 306, the analyzer provides the preprocessed data set to the recommendation module.

In Step 308, upon receiving the preprocessed data set and by employing a set of linear, non-linear, and/or ML models, the recommendation module generates a model that proactively predicts part failure probability of each of the targeted parts. In Step 310, by employing a set of algorithms (discussed above in reference to FIG. 2.1), the recommendation module trains the model to generate a trained model that, at least, (i) identifies one or more categories in the preprocessed data set, (ii) calculates/predicts part failure probability of each part in each category (prior to the manufacturing process of the product), and (iii) determine the fastest manufacturing lead time of the product based on, at least, vendor details (e.g., quality of parts procured from a vendor, easiness of procuring one or more parts from the vendor, a failure rate of each part procured from the vendor, etc.).

In Step 312, via the GUI (or an API, a programmatic interface, a communication channel, a visualizer, etc.) of the IN (e.g., 200, FIG. 2.1), the recommendation module initiates notification of an administrator (of the IN) about the trained model. In one or more embodiments, the GUI may employ a set of subroutine definitions, protocols, and/or hardware/software components for enabling/facilitating communications between the recommendation module and external entities such that the external entities may perform data item search and/or retrieval (with minimum amount of latency (e.g., with high-throughput and sub-ms latency)). In one or more embodiments, the method may end following Step 312.

Turning now to FIG. 3.2, the method shown in FIG. 3.2 may be executed by, for example, the above-discussed recommendation module. Other components of the system (100) illustrated in FIG. 1 may also execute all or part of the method shown in FIG. 3.2 without departing from the scope of the embodiments disclosed herein.

In Step 313, at a later point-in-time after the administrator is notified in Step 312 of FIG. 3.1 (or after the training of the model is completed), the recommendation module receives, via GUI of a client (e.g., 110A, FIG. 1), a product order request (e.g., a critical sales order request) for a product (e.g., a laptop, a desktop, a monitor, a server, etc.) from an entity (e.g., a user/person of the client). In one or more embodiments, the product order request may specify information including, for example (but not limited to): an identifier of a user, a shipping address of the user, a unit price of the product ordered by the user, computing resources that need to be provided by the product, a product order number, a payment term set for paying the unit price of the product, a version of an OS that the product needs to have/execute, a type of the product, etc.

In one or more embodiments, a computing resource of the computing resources may be, for example (but not limited to): a CPU, a GPU, a DPU, memory, a network resource, storage space, storage I/O, a hardware resource set, etc. In one or more embodiments, the hardware resource set may include, for example (but not limited to): a virtual central processing unit (vCPU) count, a speed select technology configuration, a hardware virtualization configuration, an input/output memory management unit configuration, a virtual network interface card (vNIC) count, a wake on local area network (LAN) support configuration, a single-root input/output virtualization (SR-IOV) status configuration, a virtual graphics processing unit (vGPU) count, a type of a vGPU scheduling policy, a type of a GPU virtualization approach that needs to be implemented, etc. Additional details of the hardware resource set are described above in reference to FIG. 1.

In Step 314, upon receiving the request and by employing the trained model, the recommendation module, at least, (i) analyzes the request based on part/computing resource details, criticality of the order, and product type of the product (because each product may have different part requirements), (ii) identifies parts need to be used to manufacture the product, and (iii) identifies which is the best vendor (by considering additional features provided by each vendor as well) to procure each “non-faulty” part (e.g., a part that is less prone to damage) in order to minimize manufacturing lead time (and the cost) of the product (so that a related manufacturing person can (a) make the most informed decision about which parts need to be procured from which vendor(s) and (b) maintain a good backlog of the parts to avoid further delays because of additional procurement, if necessary).

In Step 316, based on Step 314, the recommendation module initiates the manufacturing process of the product, for example, by sending a notification (which may include output/details of the processes performed in Step 314) to the manufacturing person employed at the manufacturer (e.g., 122, FIG. 1). Upon receiving the output, the manufacturing person may make a decision on whether or not the manufacturing process of the product should be initiated (e.g., by considering geographic locations of the best vendors recommended in Step 314, availability of those vendors, etc.).

In Step 318, via the GUI of the IN, the recommendation module initiates notification of the administrator (of the IN) to indicate that the manufacturing process of the product has been initiated. In one or more embodiments, the method may end following Step 318.

Turning now to FIG. 4, FIG. 4 shows a diagram of a computing device in accordance with one or more embodiments disclosed herein.

In one or more embodiments disclosed herein, the computing device (400) may include one or more computer processors (402), non-persistent storage (404) (e.g., volatile memory, such as RAM, cache memory), persistent storage (406) (e.g., a non-transitory computer readable medium, a hard disk, an optical drive such as a CD drive or a DVD drive, a Flash memory, etc.), a communication interface (412) (e.g., Bluetooth interface, infrared interface, network interface, optical interface, etc.), an input device(s) (410), an output device(s) (408), and numerous other elements (not shown) and functionalities. Each of these components is described below.

In one or more embodiments, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (e.g., a LAN, a WAN, Internet, mobile network, etc.) and/or to another device, such as another computing device.

In one or more embodiments, the computing device (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing a product order request, the method comprising:
obtaining, by an analyzer, historical data, wherein the historical data comprises historical product based faulty part data and historical vendor based procured part data;
analyzing, by the analyzer, the historical data to generate a data set that is associated with a set of parts of a first product;
performing, by the analyzer, preprocessing on the data set to generate a preprocessed data set, wherein the preprocessed data set is provided to a recommendation module (RM);
generating, by the RM and based on the preprocessed data set, a model that proactively predicts part failure probability of each part of the set of parts;
training, by the RM, the model to generate a trained model that, at least, identifies categories in the preprocessed data set and predicts part failure probability of each part listed in each category prior to a manufacturing process of a second product is initiated;
after the training, receiving, by the RM, the product order request from a user via a graphical user interface, wherein the request specifies information with respect to the second product;
upon receiving the request, identifying, by the RM and using the trained model, a second set of parts that need to be used to manufacture the second product and a vendor to procure each part of the second set of parts in order to minimize manufacturing lead time of the second product; and
initiating, by the RM and based on the identifying, the manufacturing process of the second product.

2. The method of claim 1, wherein the historical product based faulty part data specifies at least one selected from a group consisting of information with respect to a physically damaged part, a stage of a second manufacturing process of the first product that the physically damaged part is identified, and a product test report associated with the first product identifying a delay occurred during the second manufacturing process.

3. The method of claim 1, wherein the historical vendor based procured part data specifies at least one selected from a group consisting of a type of the first product, information of a vendor that provided a first part of the set of parts, a failure rate of a second part of the set of parts that is procured from the vendor, billing information with details of the first part procured from the vendor, and a feature provided by the vendor when the first part is procured from the vendor.

4. The method of claim 1, wherein the data set specifies at least one selected from a group consisting of an identifier of a part, an identifier of a vendor that provided the part prior to manufacturing the first product, an identifier of a second part, an identifier of a second vendor that provided the second part prior to manufacturing the first product, a type of the first product, a first geographic location of the first vendor, a second geographic location of the second vendor, a first rating of the first vendor, and a second rating of the second vendor.

5. The method of claim 1, wherein the model is a combination of a linear regression model, a decision tree classifier model, a random forest model, and an extreme gradient boosting model.

6. The method of claim 1, wherein the product order request specifies at least one selected from a group consisting of an identifier of a user, a shipping address of the user, a unit price of the second product ordered by the user, computing resources that need to be provided by the second product, a product order number, and a payment term set for paying the unit price of the second product.

7. The method of claim 6, wherein a computing resource of the computing resources is a central processing unit (CPU), a graphics processing unit (GPU), a data processing unit (DPU), memory, a network resource, storage space, storage input/output (I/O), or a hardware resource set.

8. The method of claim 7, wherein the hardware resource set specifies at least one selected from a group consisting of a virtual central processing unit (vCPU) count, a speed select technology configuration, a hardware virtualization configuration, and an input/output memory management unit configuration.

9. The method of claim 7, wherein the hardware resource set specifies at least one selected from a group consisting of a virtual network interface card (vNIC) count, a wake on local area network (LAN) support configuration, and a single-root input/output virtualization (SR-IOV) status configuration.

10. The method of claim 7, wherein the hardware resource set specifies at least one selected from a group consisting of a virtual graphics processing unit (vGPU) count, a type of a vGPU scheduling policy, and a type of a GPU virtualization approach that needs to be implemented.

11. A method for managing a product order request, the method comprising:
obtaining, by an analyzer, historical data, wherein the historical data comprises historical product based faulty part data and historical vendor based procured part data;
analyzing, by the analyzer, the historical data to generate a data set that is associated with a set of parts of a first product;
performing, by the analyzer, preprocessing on the data set to generate a preprocessed data set, wherein the preprocessed data set is provided to a recommendation module (RM);
generating, by the RM and based on the preprocessed data set, a model that proactively predicts part failure probability of each part of the set of parts;
training, by the RM, the model to generate a trained model that, at least, identifies categories in the preprocessed data set and predicts part failure probability of each part listed in each category prior to a manufacturing process of a second product is initiated; and
initiating, by the RM and via a first graphical user interface (GUI), notification of an administrator about the trained model.

12. The method of claim 11, further comprising:
after the notification of the administrator:
receiving, by the RM, the product order request from a user via a second GUI, wherein the request specifies information with respect to the second product;
upon receiving the request, identifying, by the RM and using the trained model, a second set of parts that need to be used to manufacture the second product and a vendor to procure each part of the second set of parts in order to minimize manufacturing lead time of the second product; and
initiating, by the RM and based on the identifying, the manufacturing process of the second product.

13. The method of claim 11, wherein the historical product based faulty part data specifies at least one selected from a group consisting of information with respect to a physically damaged part, a stage of a second manufacturing process of the first product that the physically damaged part is identified, and a product test report associated with the first product identifying a delay occurred during the second manufacturing process.

14. The method of claim 11, wherein the historical vendor based procured part data specifies at least one selected from a group consisting of a type of the first product, information of a vendor that provided a first part of the set of parts, a failure rate of a second part of the set of parts that is procured from the vendor, billing information with details of the first part procured from the vendor, and a feature provided by the vendor when the first part is procured from the vendor.

15. The method of claim 11, wherein the data set specifies at least one selected from a group consisting of an identifier of a part, an identifier of a vendor that provided the part prior to manufacturing the first product, an identifier of a second part, an identifier of a second vendor that provided the second part prior to manufacturing the first product, a type of the first product, a first geographic location of the first vendor, a second geographic location of the second vendor, a first rating of the first vendor, and a second rating of the second vendor.

16. The method of claim 11, wherein the model is a combination of a linear regression model, a decision tree classifier model, a random forest model, and an extreme gradient boosting model.

17. The method of claim 11, wherein the product order request specifies at least one selected from a group consisting of an identifier of a user, a shipping address of the user, a unit price of the second product ordered by the user, computing resources that need to be provided by the second product, a product order number, and a payment term set for paying the unit price of the second product.

18. The method of claim 17, wherein a computing resource of the computing resources is a central processing unit (CPU), a graphics processing unit (GPU), a data processing unit (DPU), memory, a network resource, storage space, storage input/output (I/O), or a hardware resource set.

19. A method for managing a product order request, the method comprising:
receiving, by a recommendation module (RM), the product order request from a user via a first graphical user interface (GUI), wherein the request specifies information with respect to a first product;
upon receiving the request, identifying, by the RM and using a trained model, a first set of parts that need to be used to manufacture the first product and a vendor to procure each part of the first set of parts in order to minimize manufacturing lead time of the first product; and
initiating, by the RM and based on the identifying, the manufacturing process of the first product.

20. The method of claim 19, further comprising:
prior to receiving the request from the user:
obtaining, by an analyzer, historical data, wherein the historical data comprises historical product based faulty part data and historical vendor based procured part data;
analyzing, by the analyzer, the historical data to generate a data set that is associated with a second set of parts of a second product;
performing, by the analyzer, preprocessing on the data set to generate a preprocessed data set, wherein the preprocessed data set is provided to the RM;
generating, by the RM and based on the preprocessed data set, a model that proactively predicts part failure probability of each part of the second set of parts;
training, by the RM, the model to generate the trained model that, at least, identifies categories in the preprocessed data set and predicts part failure probability of each part listed in each category prior to a second manufacturing process of the second product is initiated; and
initiating, by the RM and via a second GUI, notification of an administrator about the trained model.
